(19) United States
(12) Patent Application Publication
(10) Pub. No.: US 2009/0144257 A1
(43) Pub. Date: Jun. 4, 2009

(54) METHOD OF OPERATING A SEARCH APPLICATION

(75) Inventors: Roxane M. Chardon, Hollis, NH (US); Koranteng A. Ofosu-Amaah, Berkeley, CA (US); Brian Stout, Somerville, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/948,448

(22) Filed: Nov. 30, 2007

(51) Int. Cl. G06F 7/06; G06F 17/30

(52) U.S. Cl. 707/5; 707/E17.017; 707/E17.001

(57) ABSTRACT

A method of operating a search application, in which previous search queries have been received and stored, including receiving a current search query, searching for previous search queries including beginning portions thereof, mid-portions thereof and end-portions thereof which match a sequence of an input of the current search query in real-time, and displaying previous search queries found in the searching operation.

### BACKGROUND OF THE INVENTION

1. Field of the Invention

Aspects of the present invention relate to a method of operating a search application and, more particularly, to a method of operating a search application of a computer to display previous search queries.

2. Description of the Background

In conventional search applications, a search history is stored in a local browser cache of a user, or on a server on a network the user is logged into or connected to. When typing a current search query in the search field, the cache (or server) is examined and a drop-down window opens with a search history list of previous search queries. However, the search history list of the conventional search applications displays only left-to-right matches on the terms of the current search query. That is, once the entry deviates in a left-to-right manner from a previous search, the drop-down window closes.

Thus, if a user of conventional search applications does not start a search query string in a same manner as previous search queries, the user will receive no benefit from any information contained in the search history.

### SUMMARY OF THE INVENTION

In accordance with an aspect of the invention, a method of operating a search application, in which previous search queries have been received in a search field of the search application and stored in a local memory, is provided. The method includes receiving a current search query in the search field, the current search query including an input sequence thereof relating to a single term and/or multiple terms of the current search query, searching in the memory as the current search query is inputted for any previous search queries including beginning portions thereof, mid-portions thereof and end-portions thereof which match the input sequence of the current search query in real-time, and displaying previous search queries found in the searching operation in a navigable search history list until a search of the current search query or a subsequent searching operation is initiated.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a flow diagram of a method of operating a search application according to an exemplary embodiment of the present invention: and

FIG. 2 is a schematic diagram of a network of computers employing a search application according to an exemplary embodiment of the present invention.

### DETAILED DESCRIPTION OF THE INVENTION

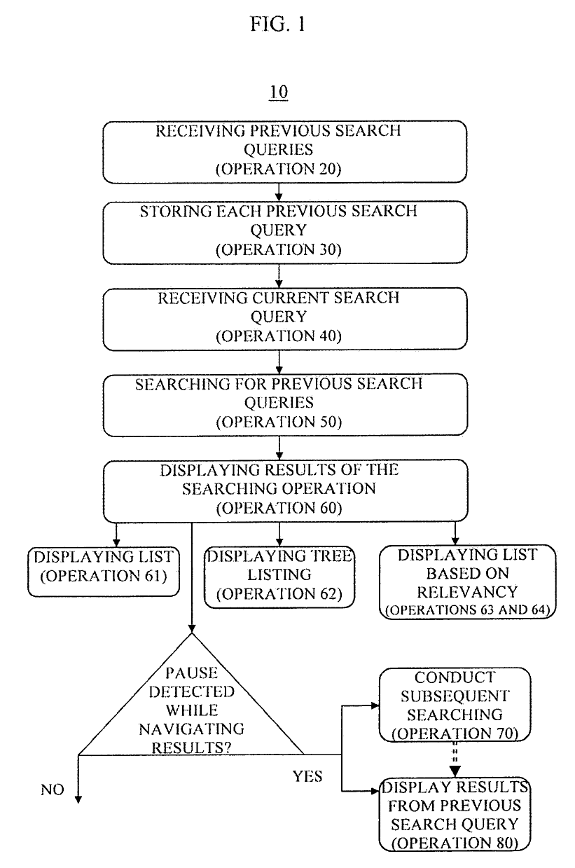

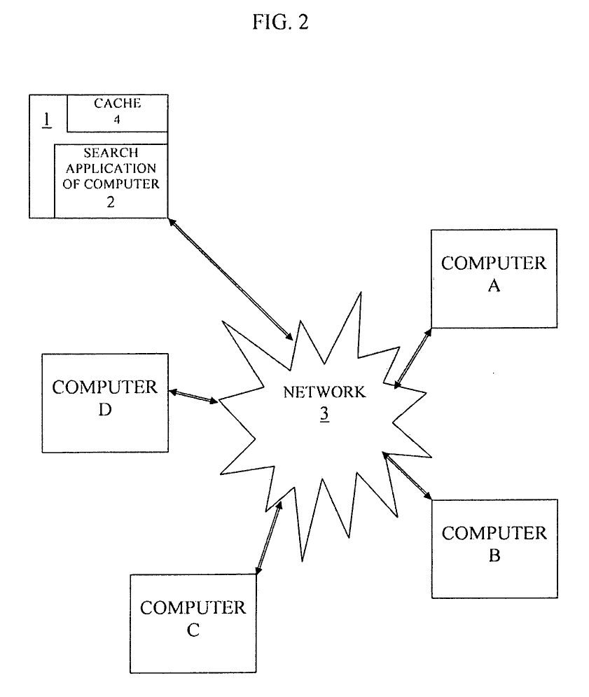

With reference to FIGS. 1 and 2, in accordance with an embodiment of the invention, a method (operation 10) of operating a search application 2 of a computer 1 to display previous search queries comprises receiving previous search queries in a search field of the search application 2 (operation 20), storing each of the previous search queries (operation 30), receiving a current search query in the search field (operation 40), the current search query including an input sequence thereof, searching for any previous search queries as the current search query is inputted including beginning portions thereof, mid-portions thereof and end-portions thereof which match the input sequence of the current search query in real-time (operation 50), and displaying previous search queries found in the searching operation in a navigable search history list until a search of the current search query is initiated (operation 60).

In accordance with various embodiments of the invention, the search application 2 could be an Internet search engine, including a search field (google.com, yahoo.com, etc.), which is accessed by the user via the computer and the network. Alternately, the search application 2 could be a file or folder finder, including a search field, that searches for files or folders saved on the computer 1 used by the user or a network 3 (LAN, WAN, etc.), including computers A-D, to which the computer 1 is connected.

In any of the above-noted cases, when the user inputs the previous search queries into the appropriate search field, the previous search queries are received (operation 20). The previous search queries are then stored in the computer 1 or on the network 3 to which the computer 1 is connected. In an embodiment of the invention, the previous search queries are stored in a cache 4 of the computer 1 or another computer connected to the network 3. However, it is understood that other storage option facilities, such as the hard disk of the computer 1 or another computer on the network 3, are available.

In the receiving of a current search query in the search field (operation 40), the current search query includes an input sequence thereof. That is, the current search query may include one or more search terms, each of which includes one or more alpha-numeric characters. The input sequence refers to the sequence that the one or more alpha-numeric characters of the one or more search terms are inputted into the search field. As an example, if the current search query is the word “context,” the input sequence is “c-o-n-t-e-x-t.” As a further example, if the current search query has multiple terms, such as the phrase “context root,” the input sequence is “c-o-n-t-e-x-t-r-o-o-t.”

With respect to the exemplary input sequence noted above, in the operation of searching in the cache 4 or the memory of the computer 1 or the network 3 for any previous search queries including beginning portions thereof, mid-portions thereof and end-portions thereof which match the input sequence of the current search query in real-time (operation 50), the searching operation searches initially for any previous search queries that include a “c” in any portions thereof. As the input sequence of the current search query is continually inputted, the searching operation continues to update the searching operation in real-time for any previous search queries that include a “co,” then a “con,” and so on until the input sequence, whether the current search query is one word or a phrase with multiple terms, is completely inputted.

It follows then, that where the current search query has multiple terms, with each individual term having one or more alpha-numeric characters, once the inputting of the input sequence is completed; the cache 4 or the memory of the computer 1 or the network 3 is searched in the searching operation 50 to match each term of the current search query with any part of the previous search queries. Thus, if the current search query is “context root,” the searching operation 50 searches for previous search queries including beginning portions thereof, mid-portions thereof or end-portions thereof that include “context” and or “root.”

Here, it is understood that, in embodiments of the invention, the searching operation 50 can be tailored to be updated only once a certain number of characters have been inputted, to search only for whole words or search terms once they are inputted, to only conduct the searching when a pause in the inputting of the input sequence is detected, or to operate in accordance with other similar tailored preferences. It is further understood that such tailored preferences can be user de-fined and set via a preferences screen of the search application 2 that can be accessed by the user.

Once results of the searching operation 50 are found, the previous search queries found in the searching operation 50 are displayed (operation 60) in a navigable search history list until a search of the current search query or a subsequent searching operation (operation 70) is initiated. In accordance with embodiments of the invention, the displaying of the previous search queries of operation 60 may comprise several display options. These include, but are not limited to, displaying a list of the previous search queries (operation 61), displaying a tree listing of the previous search queries (operation 62), determining a relative relevance value of each previous search query (operation 63) and displaying a list of the previous search queries with the most relevant previous search queries at a top thereof (operation 64), and/or displaying results from both the local computer 1 and/or another computer connected to the network 3.

Once the results are displayed in any of the above-described or other formats, if the user initiates the current search query, the displayed results are removed from the display and results of the current search query are displayed in accordance with the displaying algorithm of the search application being employed by the user.

However, if the user decides to forego the initiation of the current search query at least temporarily, the user may examine the displayed search history list via either mouse, voice actuated or keyboard controls. As the user traverses the search history list, in accordance with an embodiment of the invention, if a pause over a particular previous search query occurs and is detected, a subsequent searching operation (operation 70) may be initiated. The subsequent searching operation includes a search for previous search queries including beginning portions thereof, mid-portions thereof and end-portions thereof which match the particular previous search query.

That is, if the current search query is the term “context” and the input sequence is inputted, the results of the search for previous search queries may include exemplary previous search queries such as “context root.” “alternate context,” “alternate context root,” “change alternate context root,” and “change context root.” if the user then traverses the search history list without initiating the current search query, highlights the previous search query “alternate context” and pauses, the subsequent searching operation 70 may highlight or separate the previous search queries “alternate context root,” “change alternate context root” and “change context root.” This process may be repeated.

In another embodiment of the invention, as the user traverses the search history list, if the pause over a particular previous search query occurs and is detected, results returned when the particular previous search query was initiated may be displayed (operation 80) or a new search of the previous search query is initiated. Here, it is understood that the results of the initiation of the previous search query may be displayed in place of the results of the subsequent searching operation (70), as discussed above, or in addition to those results.

The embodiments of the methods described above can be employed for use by several users using the network 3 of computers 1 and A-D. In this case, the previous search queries of other users and the previous search results of other users can be made available to each of the users of the network 3. That is, where the user of computer “A” has previously conducted a previous search of the term “context root” but the user of computer “B” has not, if the user of computer “B” inputs the search term “context” into the corresponding search field, the searching operation 50 will return at least “context root” as a result of the searching operation 50, as described above.

While the disclosure has been described with reference to exemplary embodiments, it shill be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A method of operating a search application, in which previous search queries have been received in a search field thereof and subsequently stored in a local memory, comprising:
receiving a current search query in the search field, the current search query including an input sequence thereof relating to a single term and/or multiple terms of the current search query;
searching for any previous search queries in the local memory as the current search query is inputted, the previous search queries being searched for including beginning portions thereof, mid-portions thereof or end-portions thereof which match the input sequence of the current search query in real-time; and
displaying previous search queries found in the searching operation in a navigable search history list until a search of the current search query or a subsequent searching operation is initiated.

2. The method according to claim 1, wherein the displaying of the found previous search queries in the navigable search history list comprises at least one of:
displaying a list of the previous search queries;
displaying a tree listing of the previous search queries; and
determining a relative relevance value of each previous search query and displaying a list of the previous search queries with the most relevant previous search queries at a top thereof.

3. The method according to claim 2, wherein, as a user traverses the navigable search history list via mouse, voice actuated or keyboard controls, if a pause over a particular previous search query occurs, the method further comprises:
initiating the subsequent searching operation for previous search queries including beginning portions thereof mid-portions thereof and end-portions thereof which match the particular previous search query.

4. The method according to claim 2, wherein, as a user traverses the navigable search history list via mouse, voice actuated or keyboard controls, if a pause over a particular previous search query occurs, the method further comprises:
displaying results returned when the particular previous search query was initiated or initiating a new search for that particular previous search query.

5. A method of operating a network of computers that comprises providing aggregated search results to users of each of the computers of the network, the aggregated search results being generated in accordance with the method of claim 1.
